(19) United States
(12) Patent Application Publication
(10) Pub. No.: US 2021/0295812 A1
(43) Pub. Date: Sep. 23, 2021

(54) FLAVORED WHISTLE

(71) Applicant: Marc Pilkvist, El Segundo, CA (US)

(72) Inventor: Marc Pilkvist, El Segundo, CA (US)

(21) Appl. No.: 16/825,771

(22) Filed: Mar. 20, 2020

(51) Int. Cl. G10K 5/00; C08K 11/00; A23L 27/00

(52) U.S. Cl. CPC G10K 5/00; A23V 2002/00; A23L 27/00; C08K 11/00

(57) ABSTRACT

The present invention relates to a whistle and mouthpiece for a whistle and method of manufacturing that provides a flavored composition in the whistle mouthpiece material that the wearer can taste to make the use of the whistle more bearable over the course of its long use. A flavorant is infused within the thermoplastic material, which is dissolved to release flavor and allow the user to enjoy for a prolonged period of time. The method of manufacturing involves infusing flavorant within the thermoplastic material of the whistle mouthpiece.

### FIELD OF THE INVENTION

The present invention relates to whistles utilized in most sporting events that an official, coach or umpire utilizes to call attention to a foul, time out, interruption or other similar event. Whistles are also commonly utilized by police officers in directing traffic, calling out attention or other related occurrences. More specifically, the present invention pertains to a mouth type whistle and a method of making the same that involves infusing flavorants therein for improved taste over the course of prolonged use.

### BACKGROUND OF THE INVENTION

Whistles are utilized in many different settings and for different applications. Some whistles are used by coaches in conducting practices, while others are for use by officials and umpires during an athletic contest or event. Still others are used by police directing traffic or as an alert. The whistle serves a primary function in this setting: to direct attention to them, and arguably more importantly, for preventing a contest to continue, players to continue, or traffic to continue on when they should stop.

The whistle effectively should always be in the official's or officer's mouth to lessen the amount of time needed to call attention to them and control the event. Should an official let the whistle dangle around their neck on a string, the time lost in locating the whistle, picking it up, placing it in their mouth to direct attention and control the play, event or traffic is often crucial. Should a play go on too long, a participant may be injured or a conflict may arise if one participant felt the play had stopped, while the opponent continued. Should traffic continue when it should be stopped in an intersection, an accident may occur.

One major drawback to most whistles is that they tend to become quite filthy over a period of prolonged use. Repeated placement and removal into the mouth causes saliva, bacteria, and other elements to quickly turn a fresh whistle into a smelly, foul-tasting article that the user is forced to place in his or her mouth to be effective. It is not uncommon for users to splash the whistles with water or regularly remove the whistles frequently, as the whistle is likely foul tasting and foul smelling. This can put off the wearer, and functions as an annoyance to continued and regular use. Periods in which the whistle is not placed in the user's mouth are periods which are subject to harm that could otherwise be attenuated or outright prevented.

Most common solutions to this known drawback is the frequent replacement of whistle between games, a day, or over the course of a season. For those with the time, this is an effective solution. For those without the time (or money), is not a practical solution. Therefore, an alternative solution is desired that eliminates or reduces the bad smell and taste of a used whistle, wherein the solution does not involve discarding the whistle in favor of a replacement.

The most common form of whistles and the type herein contemplated is the inexpensive plastic type whistle. Other whistles are made up of aluminum or other metal. Many whistles are made of thickened high-impact ABS plastic. While some of these metal whistles contain a mouth grip that is made of food grade PVC claiming no smell, that smell and foul taste is simply unavoidable, once a user's saliva and bacteria is placed in and on the mouthpiece.

The present invention contemplates a new whistle that infuses a flavor into the whistle material during the production process, wherein the flavor is then tasted by the user over the course of use to reduce the foul taste and odor thereof. During the production of the whistle, a flavorant is added to the material such that a palpable flavor is detected when inserted into the user's mouth. The flavorant acts to mask the otherwise foul-smell and taste of the whistle over its use and does not break down. Overall, the device improves the user's willingness to repeatedly keep the whistle in their mouth, rather than leaving it out or continually replacing the article over the course of a day, tournament or season.

### BRIEF DESCRIPTION OF THE DRAWINGS

A complete understanding of the invention may be obtained by reference to the accompanying drawing when taken in conjunction with the detailed description thereof and in which:

FIG. 1 is a pictorial representation of a whistle.

A better understanding and appreciation of these and other objects and advantages of the present invention will be obtained upon reading the following detailed description of the preferred embodiment when taken in conjunction with the accompanying drawing.

### SUMMARY OF THE INVENTION

In view of the foregoing disadvantages inherent in the known types of whistles now present in the prior art, the present invention provides a new whistle and method of manufacturing that provides the user with a flavored and scented whistle for prolonged use.

It is therefore an object of the present invention to provide a new and improved whistle that has all of the advantages of the prior art and none of the disadvantages.

It is another object of the present invention to provide a plastic whistle cushioned protective mouth grip, wherein the material of the cushioned protective mouth grip is infused with a flavor and scent.

It is another object of the present invention to provide a metal whistle cushioned protective mouth grip, wherein the material of the cushioned protective mouth grip is infused with a flavor and scent.

Yet another object of the present invention is to provide that provides a long lasting flavor to combat foul smells and tastes from the whistle over repeated use.

Other objects, features and advantages of the present invention will become apparent from the following detailed description taken in conjunction with the accompanying drawing.

### DETAILED DESCRIPTION OF THE INVENTION

Police control traffic and referees, judges and officials all control contestants in sporting events and whistles are a way to gain attention and to alert the attention to them and to control the situation. In all cases, an office, a judge, referee or official having the whistle in his or her mouth will alert others to stop action in the quickest way, ensuring a safer situation. The invention includes the components or elements shown in the following PARTS LIST:
10. Whistle
11. Mouthpiece
12. Air Chamber
13. Upper Chamber
14 Side chamber
15. Opposing side chamber
16. Exhaust port
17. Ring hook
18. Ring
19. Notch

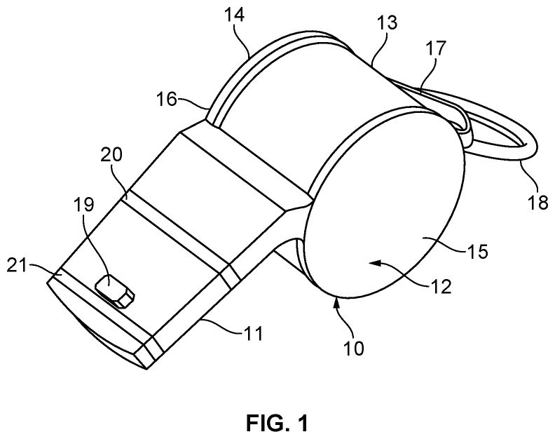

Shown in FIG. 1 is a typical whistle 10 possessing a mouthpiece 11 that includes an air chamber 12 contained within a top chamber 13 and side chambers 14 and 15, with an exhaust port 16.

In a typical situation, the whistle is 10 is hung around the neck of a user by means of a string or lanyard connected to the whistle from a ring hook 17 attached to a ring 18 where it connects the whistle 10 around the user's neck.

A notch 19 is placed on the mouthpiece 11 to enable the user to better grab and hold the whistle 10 in their mouth. The notch 19 additionally adds as a holder of any flavored mouth grip placed over the mouthpiece 11 of a metal whistle 10.

Upon observing a need to control a situation, the user will grab the whistle 10 from around his or her neck and place the whistle mouthpiece 11 in his or her mouth line and blow into it to alert the contestants to his or her attention. Once the whistle 10 is blown, the situation is controlled and attention is directed to the user who blew the whistle 10. After alerting the contestants, the play may be allowed to resume upon further direction to the official. Similarly. after alerting drivers, traffic may be allowed to resume upon further direction to the officer. The official and/or officer, upon review of the situation, may keep the whistle 10 in his or her mouth for more timely reaction, thereby preventing the situation from continuing, where dangerous situations may occur.

The whistle 10 is placed through continual steps of placing the mouthpiece 11 in the user's mouth followed by removal. The whistle 10 can be infused with flavorant. Infusion of a flavorant may be done on the mouthpiece 11 of the whistle 10. One purpose of infusion of flavorant in the whistle 10 is to encourage the whistle 10 to remain in the user's mouth and discourage the removal of the whistle 10 from the user's mouth to reduce reaction time. The length of time for which a whistle 10 will remain on a string or lanyard varies with the whistle 10 taste and smell, after which the fowl smelling whistle 10, is left more and more out of an user's mouth, since the string attaching the whistle 10 introduces some challenges such as getting tangled around the official neck.

Encouraging the user to keep their whistle 10 in their mouth is accomplished by making the whistle 10 and mouthpiece 11 pleasant tasting and smelling. Due to an unpleasant smelling and tasting whistle 10, the whistle 10 is more apt to be kept dangling around the user's neck, rather than in their mouth. A long time delay is possible with the user keeping the whistle 10 dangling around his or her neck rather than in the mouth. A flavored whistle 10 is a solution to these issues.

It should be understood that although the present invention is described in detail for its particular embodiments, there may be other variations and modifications that will become apparent to those who are skilled in the art upon reading this specification, and that these modifications or variations that can be made should not detract from the true spirit of this invention.

What is claimed is:

1) A method of producing a flavored whistle and mouthpiece, comprising the steps of:
preparing a thermoplastic material in molten form;
adding a flavoring agent to said thermoplastic material;
forming said thermoplastic material into a whistle.

2) A whistle and mouthpiece, comprising:
a whistle; said whistle and mouthpiece comprising a thermoplastic material;
a flavoring agent infused within said thermoplastic material.
